(19) United States
(12) Patent Application Publication
(10) Pub. No.: US 2009/0213227 A1
(43) Pub. Date: Aug. 27, 2009

(54) DIGITAL CAMERA FOR USE IN CONNECTION WITH COMPUTER SYSTEMS AND RELATED METHODS

(76) Inventors: Michael GREENE, Melbourne Beach, FL (US); Daniel Winkler, Melbourne Beach, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 12/107,400

(22) Filed: Apr. 22, 2008

Related U.S. Application Data
(60) Provisional application No. 61/031,047, filed on Feb. 25, 2008.

(51) Int. Cl. H04N 5/225

(52) U.S. Cl. 348/207.1; 348/E05.024

(57) ABSTRACT

A computer system includes a server configured to host a website for displaying images having at least one of a plurality of image categories associated therewith, and at least one digital camera operable to capture and communicate the images to the server. The digital camera includes an image sensor, and a processor cooperating with said image sensor and said server for capturing the images based upon a selected image category from among the plurality thereof and communicating the images to said server. The processor sets at least one attribute of the images based upon the selected image category.

### CROSS-REFERENCE TO RELATED APPLICATION

This application claims the benefit of U.S. Provisional Application Ser. No. 61/031,047, filed on Feb. 25, 2008, the contents of which are herein incorporated by reference in their entirety.

### FIELD OF THE INVENTION

The present invention relates to digital cameras and to network sales systems used in connection therewith.

### BACKGROUND OF THE INVENTION

The utility of networks, such as the Internet, to facilitate the sales of goods and services is appreciated by vendors and shoppers alike. However, one drawback of the Internet, and other networks, as a point of sale is the difficulty of physically inspecting the goods, or meeting the provider of the services, before deciding to buy.

Several websites attempt to minimize this difficulty by allowing prospective vendors to upload pictures relating to the goods or services to give shoppers a better idea of the nature of a prospective purchase. However, uploading pictures often presents difficulties with restrictions of the hosting server, such as picture file size, file type, picture dimensions, and the like.

For example, U.S. Patent Application Publication No. 2004/0199433 features a system and method for capturing conditions of items. A collection device is supplied for inputting reports about items. The collection device can include a video camera that is integral with the collection device. While the collection device can be used to enter information about vehicles, and, for a given vehicle selected, the operations of the video camera and collection device are not controlled to ensure that captured videos meet with server restrictions.

In U.S. Patent Application Publication No. 2006/004144) a digital camera is provided for acquiring digital images and a portable data entry device is provided for capturing information about inventory items. However, as with U.S. Patent Application Publication No. 2004/0199433, the operations of the digital camera and portable data entry device are not controlled to ensure that captured digital images meet with server restrictions.

Particularly for vendors with extremely large inventories of goods or services to be sold over the network, the time and effort required to comply with restrictions and add associated information can be excessive.

### SUMMARY OF THE INVENTION

In view of the foregoing background, it is therefore an object of the present invention to provide a computer system, digital camera for use therewith, and related methods that facilitate processing of images.

According to an embodiment of the present invention, a computer system includes a server configured to host a website for displaying images having at least one of a plurality of image categories associated therewith, and at least one digital camera operable to capture and communicate the images to the server.

According to an aspect of the present invention, the digital camera includes an image sensor, and a processor cooperating with said image sensor and said server for capturing the images based upon a selected image category from among the plurality thereof and communicating the images to said server. The processor sets at least one attribute of the images based upon the selected image category.

According to further aspects of the present invention, the images include video images and the image categories comprise at least one of goods and services image categories.

According to a method aspect of the present invention, an image processing method includes capturing images using a digital camera based upon a selected image category from among a plurality of image categories, at least one attribute of the images being set by the digital camera based upon the selected image category. The captured images are communicated to a server hosting a website and displayed on the website based upon respective image categories associated with the images.

### BRIEF DESCRIPTION OF THE DRAWINGS

FIG. 1 is an organizational view of a network sales system including a digital camera, according to an embodiment of the present invention.

FIGS. 2-4 are views of web pages associated with the system of FIG. 1.

FIG. 5 is a front perspective view of the digital camera of FIG. 1.

FIG. 6 is a rear perspective view of the digital camera of FIG. 1.

FIG. 7 is a flow diagram illustrating operation of the digital camera in connection with the system of FIG. 1.

FIGS. 8-15 are views of screen displays of the digital camera of FIG. 1.

### DETAILED DESCRIPTION OF A PREFERRED EMBODIMENT

The present invention will now be described more fully hereinafter with reference to the accompanying drawings, in which a preferred embodiment of the invention is shown. This invention may, however, be embodied in many different forms and should not be construed as limited to the embodiment set forth herein. Rather, this embodiment is provided so that this disclosure will be thorough and complete, and will fully convey the scope of the invention to those skilled in the art. Like numbers refer to like elements throughout.

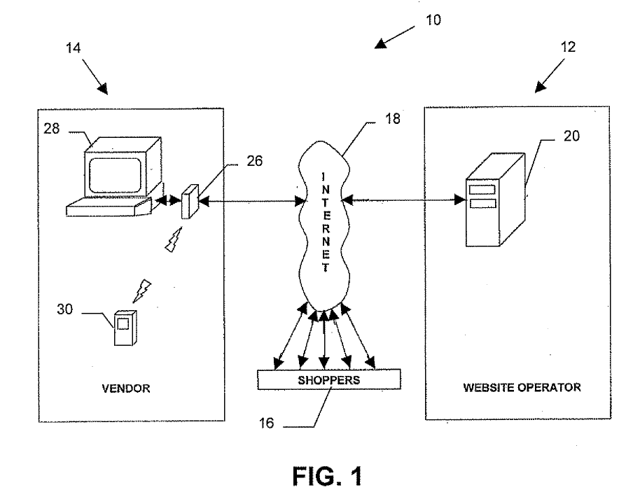

Referring to FIG. 1, a network sales system 10 includes a system operator 12, such as a website operator, at least one vendor 14 and a plurality of shoppers 16. The operator 12, vendor 14 and shoppers 16 are connected through a network 18, such as the Internet.

The system operator 12 has a server 20 connected to the network 18. The server 20 is configured to host a website accessible to the vendor 14 and shoppers 16 over the network 18.

The vendor 14 has a network access device 26, such as a wireless gateway, connected to the network 18. The vendor 14 also has a computer 28 connected to the network access device 26 and a digital video camera 30 configured to communicate with the network access device 26. In the illustrated embodiment, the connection is a wireless connection (e.g., 802.11, Bluetooth, etc.), but wired connections (e.g. USB, etc.) may also be used.

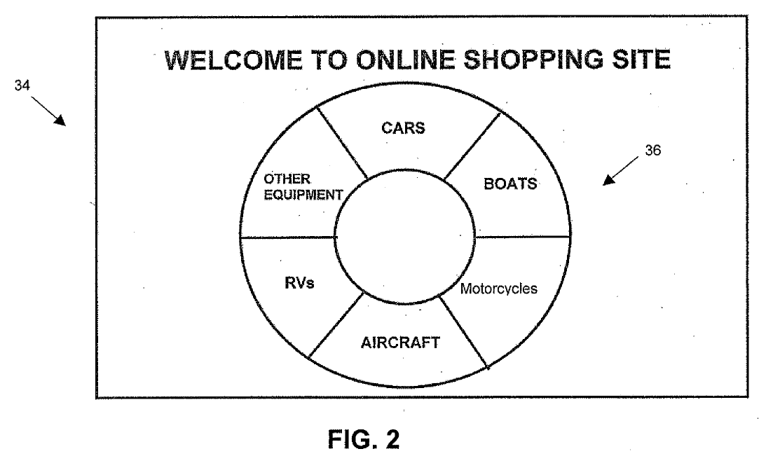

Referring to FIG. 2, the website hosted by the server 20 includes a shopper homepage 34. The shopper homepage 34 is configured to allow the shoppers 16 to select from a plurality of categories 36. The plurality of categories include, for example, categories of goods for sale, such as cars, boats, motorcycles, aircraft, recreational vehicles (RVs), and other equipment.

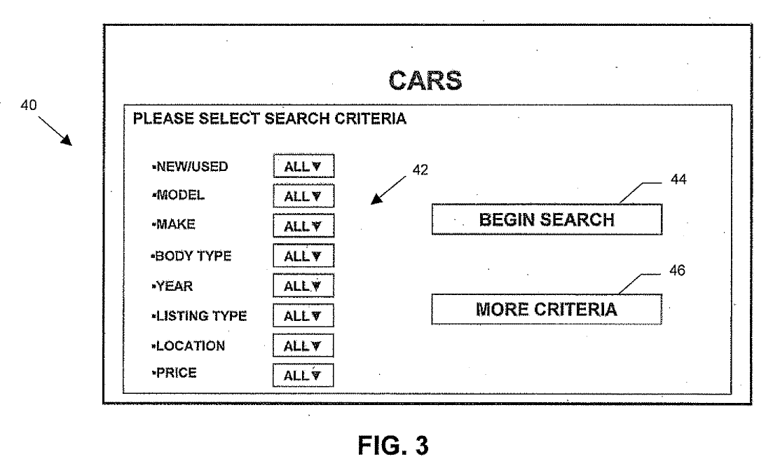

Referring to FIG. 3, upon selection of one of the plurality of categories 36, the server 20 displays a search page 40. The search page 40 is configured to allow the shoppers 16 to specify a plurality of search criteria 42 related to the particular category 36 selected. For example, upon selection of cars as the category 36, the search page 40 allows shoppers 16 to specify car-related search criteria, such as new or used, model, make, body type, year, listing type, location and price.

The search page 40 is further configured with a “Begin Search” selection 44, allowing the shoppers 16 to direct the server 20 to begin searching within the category 36 based on any search criteria 42 that were specified. Additionally, the search page 40 is configured with a “More Criteria” selection 46, allowing the shoppers 16 to specify additional search criteria. For example, for a car category 36, additional search criteria such as particular trim options, are specifiable. Once the “Begin Search” selection 44 is used, the server 20 searches the selected category 36, limiting the search results based on the specified search criteria 42, as well as any additional search criteria specified.

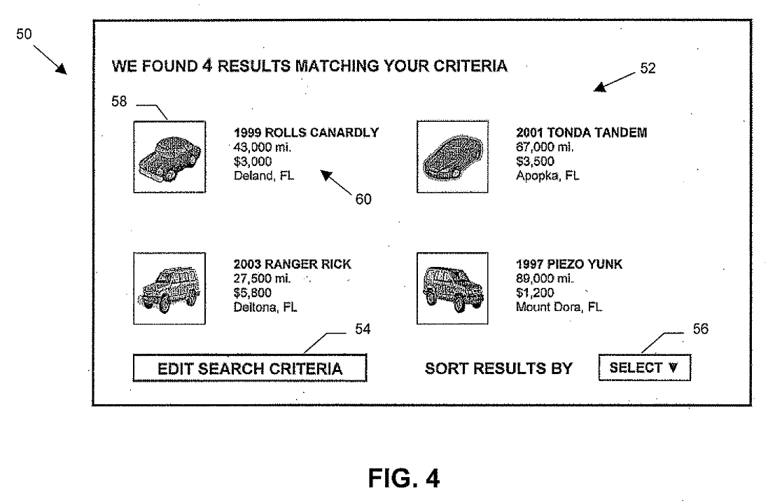

Referring to FIG. 4, once the search is complete, the server 20 displays a search results page 50. The search results page 50 is configured to display a plurality of search results 52. The search results page 50 is also configured with an “Edit Search Results” selection 54 and a “Sort Results” selection 56.

The “Edit Search Criteria” selection 54 allows shoppers 16 to modify previous specifications and add additional specifications to change or further limit the search results. The “Sort Results” selection 56 allows shoppers 16 to order the search results 52 based on different search criteria, such as price or mileage. It should be noted that different homepage, search page, and results page configurations/layouts may be used in different embodiments.

Search results 52 displayed on the search results page 50 may include a still capture 58 from a video relating to the search result 52, such as a still capture from a video of a car, and overview data 60 having basic information about the search result 52 in a textual format. The server 20 is configured to play the video and display more detailed information on a separate page upon selection of a particular search result 52 by a shopper 16.

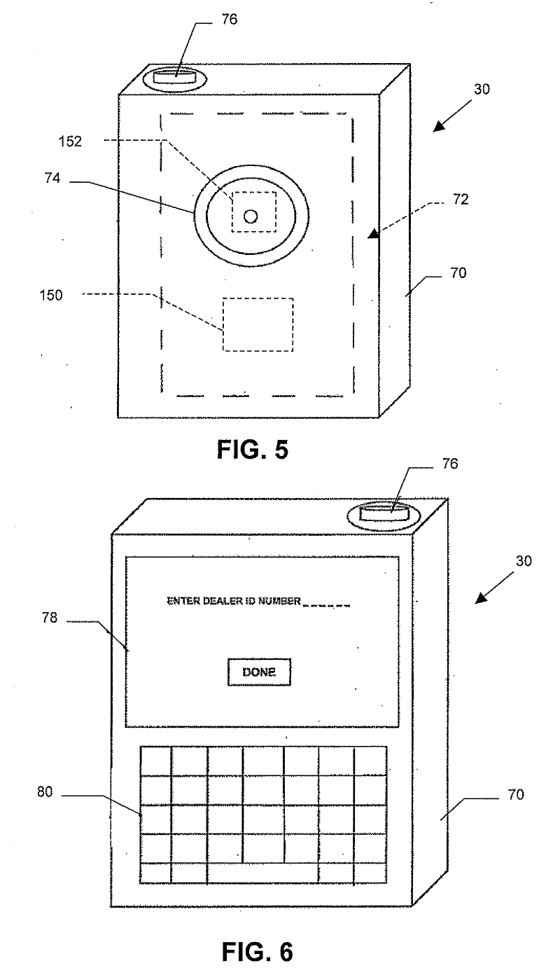

Referring to FIGS. 5 and 6, digital video camera 30 includes a housing 70 with camera electronics 72 enclosed therein. The camera electronics 72 include, for example, a microprocessor 150 and an image sensor 152, as well as memory storage, batteries and the like. The image sensor 152 can include, for example, a charge coupled device (CCD) or a complementary metal oxide semiconductor (CMOS). A lens arrangement 74 on a front side of the camera 30 can be optically coupled to the image sensor 152, as will be appreciated by the skilled artisan. Power button 76 allows the camera 30 to be turned on and off.

A screen 78 is arranged on a rear side of the camera 30, as well as an input device 80, such as a keypad, for example. The screen 78 and input device 80 allow a vendor 14 to interface with the camera 30, as will be described in detail below.

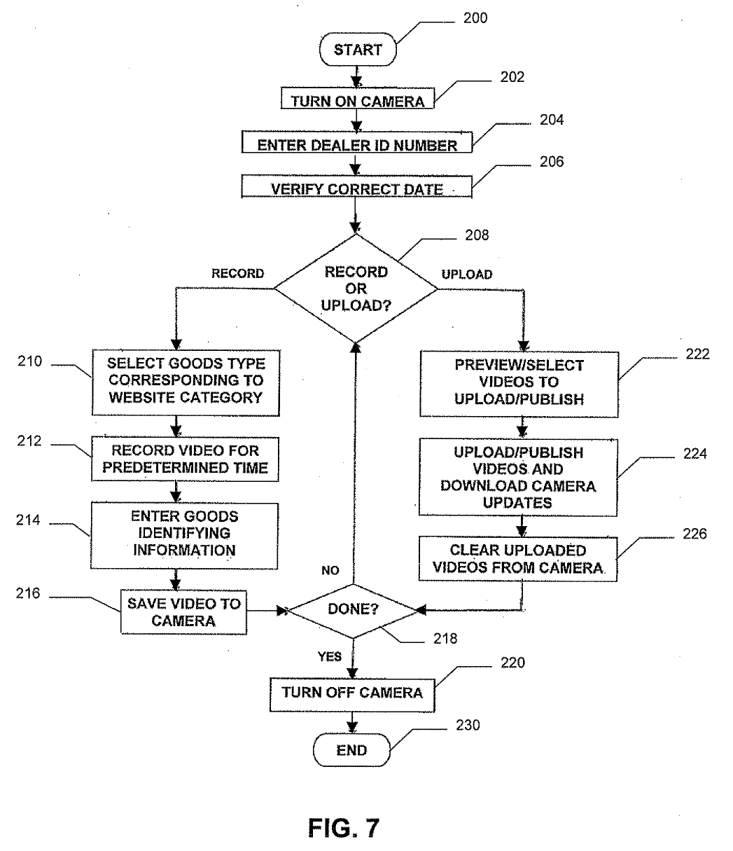

With reference to FIG. 7 and FIGS. 8 through 15, operation of the camera 30 in connection with the system 10 is explained. Referring to FIG. 7, operation starts at block 200 with the vendor 14 turning on the camera 30 at block 202, using the power button 76.

At block 204, the camera 30 may prompt the vendor 14 personnel to enter a vendor specific identification (ID), such as a unique dealer ID number. A dealer, or other vendor, ID number includes, for instance six digits with the first two digits advantageously corresponding to the location, such as the state, of the dealer. In some embodiments, the dealer ID number may need only be entered on first use of the camera, and it is saved in the camera's memory to associate with later video captures.

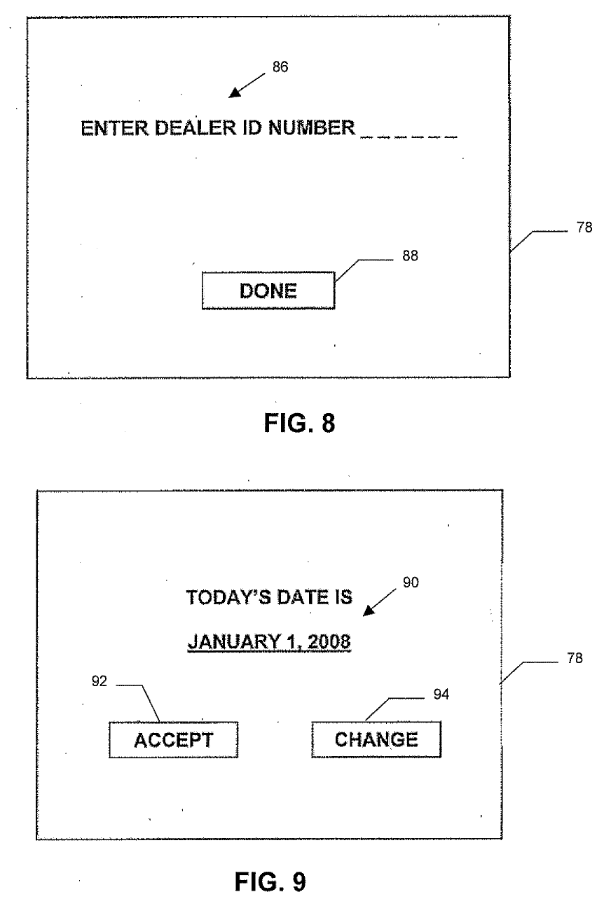

Referring to FIG. 8, screen 78 of the camera 30 displays a vendor ID prompt 86. Digits of the ID number are entered by the vendor 14 using the input device 80. Vendor 14 inputs throughout are accomplished using the input device 80, unless otherwise specified. A “Done” selection 88 is displayed for use once the vendor ID has been entered. In some embodiments, the input device 80 may be remotely located from the camera housing 70, and could for example be a mobile wireless communication device (e.g. cellular phone) or computer (e.g. laptop) that communicates wirelessly with the camera's processor, etc.

Referring again to FIG. 7, after the vendor ID number has been entered at block 204, the correct date is verified at block 206. Referring to FIG. 9, the screen 78 may display an automatically determined date 90, as well as “Accept” and “Change” selections 92, 94. If the vendor 14 is satisfied with the date 90, the “Accept” selection 92 is used. Otherwise, the “Change” selection 94 is used and a new date is entered with the input device 80. The date information may be obtained from connection to the website computer or it could also be manually entered by the user, the user need not automatically be prompted to verify the date on every session (or at all in some embodiments).

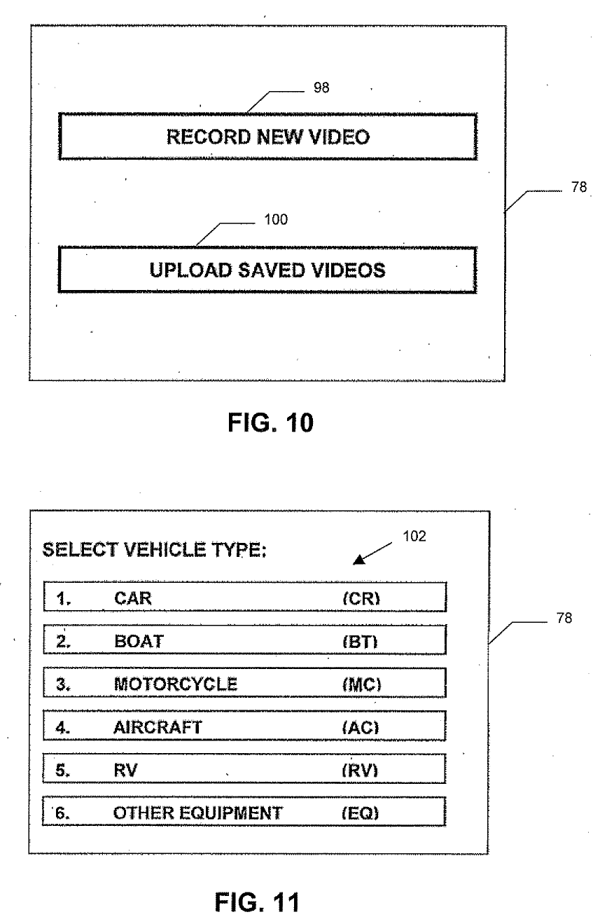

Referring again to FIG. 7, at block 208 the vendor 14 may be prompted to select either recording a new video or uploading saved videos to the server 20. Referring to FIG. 10, the screen 78 displays “Record New Video” and “Upload Saved Videos” selections 98, 100 for use by the vendor 14.

Once the “Record New Video” selection 98 is used, referring again to FIG. 7, at block 210 the user may be prompted to select a category corresponding to the categories 36 of the website hosted by the server 20. As seen in FIG. 11, a plurality of category selections 102, such as “Vehicle Type” selections, are displayed on the screen 78 which correspond to the categories 36. A default selection could also be used (such as the last selection used) in some embodiments, which the user could accept or change if desired.

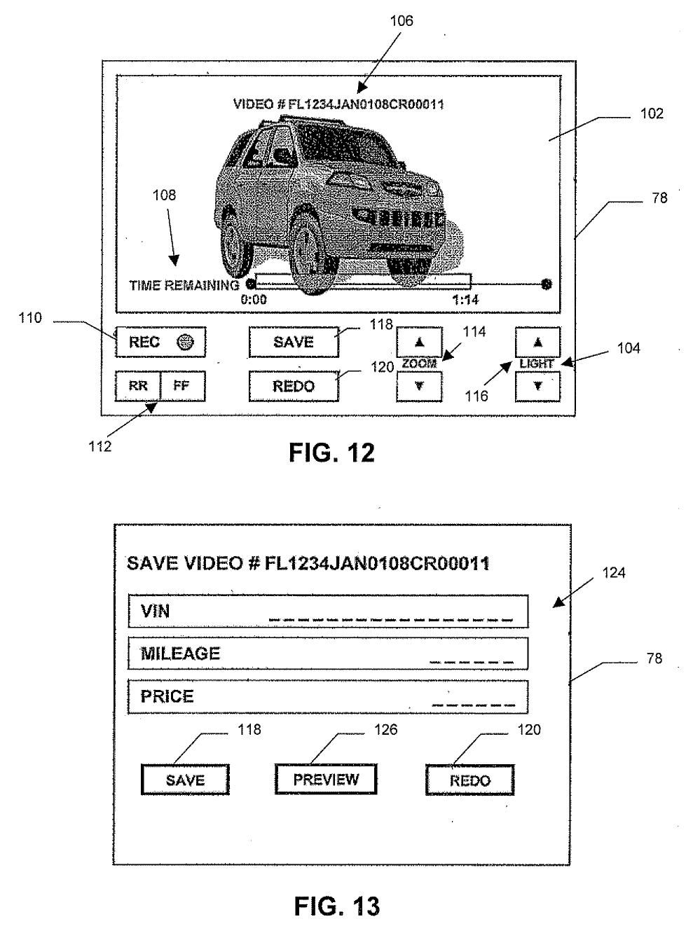

After a category selection is made, referring again to FIG. 7, at block 212 a video is recorded for a predetermined time or up to a predetermined file capture size. Referring to FIG. 12, upon making a category selection, the screen 78 displays a recording window 102 and control bar 104. The recording window 102 displays the image being captured through the lens arrangement 74. A video ID number 106 and a time remaining indicator 108 are superimposed over the image in the recording window.

The video ID number 106 advantageously includes multiple segments. For example, the video ID number FL1234JAN0108CR00011 displayed on screen 78 includes a vendor ID segment (FL1234), a date segment (JAN0108) and a category segment (CR), as well a sequential numbering segment (00011) indicating the number of videos taken by the particular vendor 14.

The time remaining indicator 108 in the illustrated example is a slider bar that counts down the time left for video capture, although other indicators may also be used. The total time for video capture is preset in the camera 30 based on the category selected at block 210. Examples of preset video times for the categories shown in FIGS. 2 and 11 are shown in the following table. Of course, other time durations may also be used.

| CATEGORY | PRESET TIME (mm:ss) |
|---|---|
| Cars | 01:30 |
| Boats | 10:00 |
| Motorcycles | 00:30 |
| Aircraft | 10:00 |
| RVs | 05:00 |
| OTHER EQUIPMENT | 01:00 |

The control bar 104 illustratively includes a record control 110, allowing the vendor 14 to start and stop recording, as well as jog controls 112, allowing the vendor 14 to fast forward or rewind through already recorded video when recording is stopped. The control bar 104 also illustratively includes zoom and light level controls 114, 116.

A “Save” selection 118 in the control bar allows the vendor 14 to save the recorded video once the vendor 14 is satisfied. Alternately, a “Redo” selection 120 allows the vendor 14 to abandon the recorded video, make a new category selection, if desired (as in FIG. 11), and record a new video. Other control bar 104 configurations are also possible, and rather than appearing on the screen 78, one or more control bar 104 controls could be permanent hardware controls on the housing 70.

Once the “Save” selection 118 is used, referring again to FIG. 7, at block 214 the camera 30 prompts the vendor 14 to enter identifying information about subject of the video, for instance identifying information about a car captured in the video. Referring to FIG. 13, screen 78 may display a plurality of identifying information entrance prompts 124. In the example of a video of a car, the prompts 124 allow the entrance of car-related identifying information, such as vehicle identification number (VIN), mileage and price.

The “Save” selection 118 may be repeated for use when the vendor 14 is satisfied with the entered identifying information. The vendor 14 need not be required to enter all prompted identifying information, and may save the video and enter the information at a later time. The “Redo” selection 120 may also be repeated for use if the vendor 14 is dissatisfied and wants to abandon the video. A “Preview” selection 126 is also illustratively displayed for use if the vendor 14 desires to re-watch the video before deciding to save or redo.

Referring again to FIG. 7, at block 216 the video is saved. Once the video is saved, any identifying information entered is automatically associated with the video and saved with it. At block 218, if the vendor 14 is done with camera 30 operations for the present, the vendor turns off the camera 30 (block 220). If the vendor 14 does not turn off the camera 30, the vendor 14 is again prompted to select either recording a new video or uploading saved videos to the server 20 (see also FIG. 10). The camera 30 may also have an automatic power off feature after a predetermined duration of user inactivity.

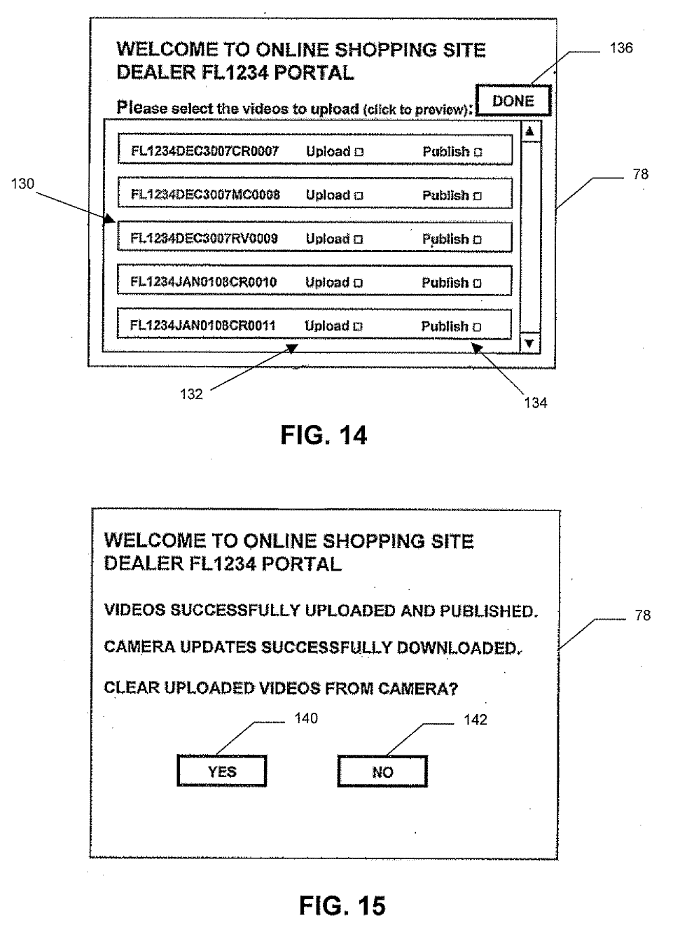

If the vendor 14 uses the “Upload Saved Videos” selection 100, at block 222, the videos to be uploaded or published are previewed and selected. Referring to FIG. 14, the camera 30 establishes a wireless (or wired) connection with the computer 28 and/or network access device 26, through which a connection with the server 20 is made.

In accordance with one embodiment, the screen 78 displays a list 130 of saved videos that have not been uploaded. For each video on the list 130, “Upload” and “Publish” selections 132, 134 may be displayed. The upload option may allow a user to first upload or save a file(s) to the website or computer 28 but without yet making it viewable or accessible to the shoppers 16. Once the desired selection is made for each video on the list 130, a “Done” selection 136 is used. Referring again to FIG. 7, upon making the “Done” selection 136, at block 224 the “Upload” selected videos from the list 130 are uploaded to the server 20. The “Publish” selected videos from the list 130 are uploaded to the server 20 and the video and associated identifying information are published to the website, becoming accessible to the shoppers 16 through the network 18. However, separate upload and publish options need not be provided in all embodiments. For example, the file could first be stored on the computer 28, and published to the website in due course upon transfer thereto by the user.

Advantageously, identifying information beyond the identifying information entered by the user (see FIG. 13) may automatically be associated with the corresponding video by the server 20. For instance, based on the vendor ID, location information, such as dealer city and state, and listing type information, such as dealer or private seller, may automatically be associated with the video.

Additionally, based on an identifying number, such as a VIN for cars or a hull identification number (HIN) for boats, additional information may be associated with the corresponding video. For example, based on a car's VIN, the car's make, model, year, color and trim package may be retrieved from a third party database via the Internet and automatically associated with the given car video, for example.

Referring again to FIG. 7, as well as to FIG. 15, at block 224 updates may also downloaded to the camera 30. For instance, if an additional category 36 is added to the website hosted by the server 20, the corresponding category is added to the list displayed in FIG. 11. As another example, if the preset video length associated with a category is changed, for instance based on a change in subscription or package level of the vendor 14, then the time remaining indicator 108 will be updated for videos subsequently captured in that category.

At block 226, the user is prompted to clear uploaded videos from the camera 30. Referring again to FIG. 15, the screen 78 displays “Yes” and “No” selections 140, 142 to allow the vendor 14 to either retain the videos in the memory of the camera 30 or clear the videos, for example. As before at block 218 of FIG. 7, if the vendor 14 is done, the camera 30 is turned off, using the power button 76, and operations end at block 230.

Many modifications and other embodiments of the invention will come to the mind of one skilled in the art having the benefit of the teachings presented in the foregoing descriptions and the associated drawings.

In the exemplary embodiment, the present invention is described in the context of a network sales system. While the present invention is advantageous in this context, the present invention is also applicable to other computer systems unrelated to the advertisement of goods or services for sale.

Also, the present invention is not necessarily limited to particular network access equipment, networks or servers, or types of connection between components. Additionally, functions described herein as execution by a particular component are not necessarily limited to execution by that component, and functions can be shared between different components and re-assigned within the scope of the present invention

Additionally, the present invention is not necessarily limited to any particular website design or configuration. For instance other categories of goods or services can be used besides those shown herein. Also, other search criteria and results displays can be implemented within the scope of the present invention.

Furthermore, the present invention is not necessarily limited to the use of any particular type of digital cameras or to the capture of videos. Other images, such as still photos, can be used within the scope of the present invention, and attributes of those images can be preset to correspond to a particular category of goods or surfaces. For example, image resolution, image dimensions or number or images captured by a camera according to the present invention, could be preset for a particular category of goods or services.

Moreover, cameras with other input devices, external or internal, can fall within the scope of the invention. Rather than, or in addition to, the keypad shown, examples of other input devices include touch screen displays, touch pads, and trackballs.

Also, the present invention is not necessarily limited to the association of a particular type of information with a captured video or other image. For example, other types of identifying information can be entered or automatically associated with the video or other image. Automatically associated information can be derived from multiple sources, including data stored on the server or accessed by the server from third party databases.

The foregoing is not an exhaustive list of the modifications and other embodiments of the invention that will come to the mind of one skilled in the art having the benefit of the teachings presented in the foregoing descriptions and the associated drawings. Therefore, it is understood that the invention is not to be limited to the specific embodiment disclosed, and that modifications and embodiments are intended to be included within the scope of the appended claims.

What is claimed is:

1. A computer system comprising:
a server configured to host a website for displaying images having at least one of a plurality of image categories associated therewith; and
at least one digital camera comprising
an image sensor, and
a processor cooperating with said image sensor and said server for capturing the images based upon a selected image category from among the plurality thereof and communicating the images to said server;
said processor also setting at least one attribute of the images based upon the selected image category.

2. The computer system of claim 1 wherein the image categories comprise at least one of goods and services image categories.

3. The computer system of claim 1 wherein the images comprise video images.

4. The computer system of claim 3 wherein the at least one attribute comprises a video duration.

5. The computer system of claim 1 wherein the at least one attribute comprises at least one of an image file size and an image resolution.

6. The computer system of claim 1 wherein said processor further cooperates with the server to receive updates to the at least one image attribute.

7. The computer system of claim 1 wherein said processor further cooperates with the server to receive updates to the image categories.

8. The computer system of claim 1 wherein said processor further associates identification (ID) numbers with the captured images, the ID numbers having category segments corresponding to respective selected image categories.

9. The computer system of claim 8 wherein the ID numbers also have user ID segments identifying respective users.

10. The computer system of claim 1 wherein said processor communicates the images to the server through at least one network.

11. A computer system comprising:
a server configured to host a website for displaying images having at least one of a plurality of image categories associated therewith, the image categories comprising at least one of goods and services image categories; and
at least one digital camera comprising
an image sensor, and
a processor cooperating with said image sensor and said server for capturing the images based upon a selected image category from among the plurality thereof and communicating the images to said server,
said processor also setting at least one attribute of the images based upon the selected image category;
wherein the images comprise video images.

12. The computer system of claim 11 wherein said processor also sets at least one attribute of the images based upon the selected image category.

13. The computer system of claim 12 wherein the at least one attribute comprises at least one of a video duration, an image file size and an image resolution.

14. The computer system of claim 11 wherein said processor further cooperates with the server to receive updates to at least one of the image categories and the at least one image attribute.

15. A digital camera comprising:
an image sensor; and
a processor cooperating with said image sensor for capturing images based upon a selected image category from among a plurality of image categories, communicating the images to a server hosting a website for displaying the images based upon respective image categories associated therewith, and setting at least one attribute of the images based upon the selected image category.

16. The digital camera of claim 15 wherein the image categories comprise at least one of goods and services image categories.

17. An image processing method comprising:
capturing images using a digital camera based upon a selected image category from among a plurality of image categories, at least one attribute of the images being set by the digital camera based upon the selected image category;
communicating the captured images to a server hosting a website; and
displaying the images on the website based upon respective image categories associated with the images.

18. The method of claim 17 wherein the image categories comprise at least one of goods and services image categories.

19. The method of claim 17 wherein the images comprise video images; and wherein the at least one attribute comprises a video duration.

20. The method of claim 17 wherein the at least one attribute comprises at least one of an image file size and an image resolution.
